(19) United States
(12) Patent Application Publication
(10) Pub. No.: US 2025/0285385 A1
(43) Pub. Date: Sep. 11, 2025

(54) IMAGE PROCESSING METHOD, DEVICE AND STORAGE MEDIUM

(71) Applicant: Beijing Zitiao Network Technology Co., Ltd., Beijing (CN)

(72) Inventor: Qi YUAN, Beijing (CN)

(21) Appl. No.: 18/860,587

(22) PCT Filed: Mar. 14, 2023
(86) PCT No.: PCT/CN2023/081253

§ 371 Date: Oct. 25, 2024

(30) Foreign Application Priority Data
Apr. 26, 2022 (CN) 202210451633.9

(51) Int. Cl. G06T 19/00; G06T 7/11; G06T 7/55; G06T 15/00

(52) U.S. Cl. CPC G06T 19/006; G06T 7/11; G06T 7/55; G06T 15/005; G06T 2207/20021; G06T 2207/20221; G06T 2207/30201

(57) ABSTRACT

An image processing method, a device, and a storage medium are provided. The image processing method includes: dividing a set portion of a target object to obtain an initial mask map; acquiring a first depth map of a virtual object and a second depth map of a standard virtual model relating to the target object; adjusting the initial mask map based on the first depth map and the second depth map to obtain a target mask map; rendering the set portion based on the target mask map to obtain a set portion map; and rendering the virtual object to obtain a virtual object map; and superimposing the set portion map and the virtual object map to obtain a target image.

The present disclosure claims priority to Chinese Patent Application No. 202210451633.9 filed on Apr. 26, 2022 to the Chinese Patent Office, the entire contents of which are incorporated by reference in the present disclosure.

### TECHNICAL FIELD

Embodiments of the present disclosure relate to the technical field of image processing, for example, to an image processing method, apparatus, device and storage medium.

### BACKGROUND

By adding a virtual object on the detected target object is a common application scenario in augmented reality today. In this application scenario, when adding the virtual object, it is necessary to determine an occlusion relation of the virtual object and the target object, based on the occlusion relation, the virtual object and the target object are rendered.

In the related art, the occlusion relation of the virtual object and the target object is determined by a standard virtual model, in such a way, because the standard virtual model is a fixed size, which cannot be matched with various target objects, the determined occlusion relation is not accurate, and the virtual object and the target object are not sufficiently conformed, affecting the realism of the image.

### SUMMARY

Embodiments of the present disclosure provide an image processing method, apparatus, device and storage medium, which can realize the adding of a virtual object to a target object, thereby improving the realism of the virtual object.

In the first aspect, embodiments of the present disclosure provide an image processing method, which includes:
dividing a set portion of a target object to obtain an initial mask map;
acquiring a first depth map of a virtual object and a second depth map of a standard virtual model relating to the target object;
adjusting the initial mask map based on the first depth map and the second depth map to obtain a target mask map;
rendering the set portion based on the target mask map to obtain a set portion map; and rendering the virtual object to obtain a virtual object map; and
superimposing the set portion map with the virtual object map to obtain a target image.

In the second aspect, embodiments of the present disclosure further provide an image processing apparatus, which includes:
an initial mask map acquisition module, configured to divide a set portion of a target object to obtain an initial mask map;
a depth map acquisition module, configured to acquire a first depth map of a virtual object and a second depth map of a standard virtual model relating to the target object;
a target mask map acquisition module, configured to adjust the initial mask map based on the first depth map and the second depth map to obtain a target mask map;
a rendering module, configured to render the set portion based on the target mask map to obtain a set portion map; and render the virtual object to obtain a virtual object map; and
a target image acquisition module, configured to superimpose the set portion map and the virtual object map to obtain a target image.

In the third aspect, embodiments of the present disclosure further provide an electronic device, the electronic device includes:
a processing apparatus; and
a storage apparatus, configured to store a program;
when the program is executed by the processing apparatus, the processing apparatus implements the image processing method according to the embodiments of the present disclosure.

In the fourth aspect, embodiments of the present disclosure further provide a computer readable medium, a computer program is stored on the computer readable medium, and when the computer program is executed by a processing apparatus, the computer program implements the image processing method according to the embodiments of the present disclosure.

### BRIEF DESCRIPTION OF DRAWINGS

FIG. 1 is a flowchart of an image processing method provided by the embodiments of the present disclosure;

FIG. 2 is an initial mask map after dividing of a face provided by the embodiments of the present disclosure;

FIG. 3a is a depth map of a virtual object provided by the embodiments of the present disclosure;

FIG. 3b is a depth map of a standard virtual model provided by the embodiments of the present disclosure;

FIG. 4 is an example diagram of a two-dimensional map provided by the embodiments of the present disclosure;

FIG. 5 is an example diagram of a mask map after adjusting provided by the embodiments of the present disclosure;

FIG. 6 is an example diagram of processing frame delay provided by the embodiments of the present disclosure;

FIG. 7 is an example diagram of adding a virtual object to a target object provided by the embodiments of the present disclosure;

FIG. 8 is a structural diagram of an image processing apparatus provided by the embodiments of the present disclosure; and

FIG. 9 is a structural diagram of an electronic device provided by the embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. It should be understood that the drawings and the embodiments of the present disclosure are only for exemplary purposes.

It should be understood that various steps recorded in the implementation modes of the method of the present disclosure may be performed according to different orders and/or performed in parallel. In addition, the implementation modes of the method may include additional steps and/or steps omitted or unshown.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information interacted between devices in an implementation of the present disclosure are for illustrative purposes only and are not intended to limit the scope of such messages or information.

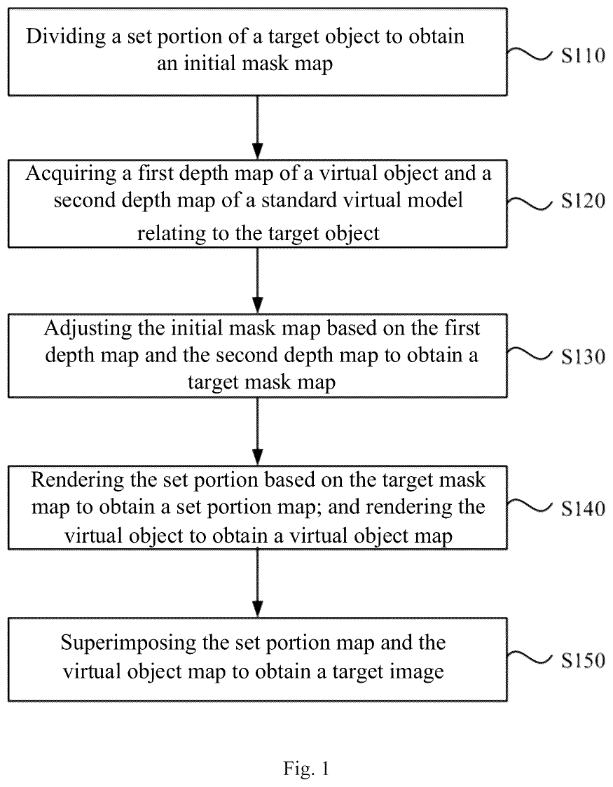

FIG. 1 is a flowchart of an image processing method provided by the embodiments of the present disclosure, this embodiment is applicable to the case where a virtual object is added to an image, the method can be performed by an image processing apparatus, which may be composed of hardware and/or software, and may be generally integrated in a device having an image processing function, the device may be an electronic device such as a server, a mobile terminal, or a server cluster. As shown in FIG. 1, the method may include the following steps.

S110, dividing a set portion of a target object to obtain an initial mask map.

The target object may be a real object recognized in the current scene, or a real object configured to need to be added with a virtual object, for example, the target object may be a human body, a plant, a vehicle, and a building, etc. The set portion may be a portion which has an occlusion relation with the added virtual object, and may be determined according to the adding position of the virtual object. For example, when the target object is a human body and the virtual object is added on the top of the head, the set portion may be a hair region, and when the virtual object is added on the neck, the set portion may be a face region, or the like.

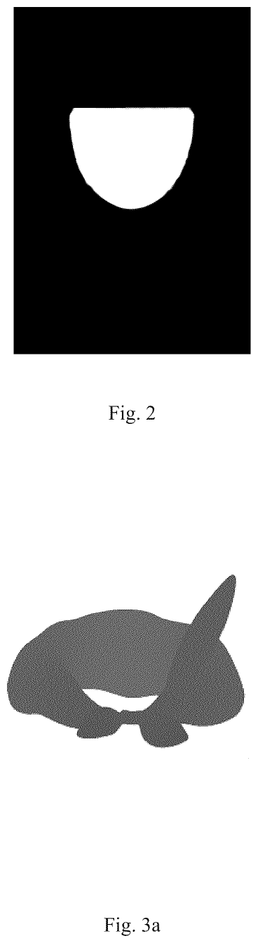

Exemplarily, the process of dividing the set portion of the target object to obtain the initial mask map may be: detecting the set portion on an image including the target object, obtaining a confidence that a pixel in the image belongs to the set portion, and using the confidence as a pixel value of the pixel, to obtain the initial mask map. Illustratively, FIG. 2 is an initial mask map after dividing of the face in this embodiment. As shown in FIG. 2, the white region represents the face region and the black region is the non-face region. The face region can be divided out from this initial mask map.

S120, acquiring a first depth map of a virtual object and a second depth map of a standard virtual model relating to the target object.

The virtual object may be an arbitrary constructed virtual object, and the virtual object may be an irregularly shaped object, for example, the virtual object may be a virtual animal (e.g., a cat, a dog, etc.), a virtual headwear, a virtual earring, a virtual object that may be added on the neck (e.g., a virtual necklace, a virtual neck pillow, etc.), and the like. In the present embodiment, the number of virtual objects may be set according to actual requirements, for example, the virtual object may be a combination of a virtual animal and a virtual neck pillow, or the like.

The standard virtual model may be a virtual model relating to a target object, and may be a virtual model used in place of the target object for depth detection. The standard virtual model may be a virtual model of a shape of the target object, or a virtual model associated with the shape of the target object, or a virtual model constructed for the target object based on the current frame. For example, when the target object is a human head, the standard virtual model is a virtual model of a human head shape, and the shape associated with the target object shape may be a virtual model of a cube shape or a cylinder shape. The virtual model of the shape of the target object and the virtual model associated with the shape of the target object may be pre-created. The virtual model constructed based on the target object of the current frame may be understood as: a standard virtual model constructed in real time based on the target object.

The way of constructing the virtual model based on the target object of the current frame may be: scanning the target object of the current frame in 3D dimensions (3D), to obtain 3D data of the target object, and constructing the standard virtual model based on the 3D data. In this embodiment, the amount of computation can be reduced by using the virtual model associated with the shape of the target object. Constructing the standard virtual model in real time based on the target object can improve the accuracy of depth detection.

In this embodiment, the first depth map of the virtual object may be a depth map after the virtual object is added to the target object; and the second depth map of the standard virtual model may be a depth map after the standard virtual model is added to the target object.

In this embodiment, the manner of acquiring the first depth map of the virtual object may be: tracking the object adding portion based on a set tracking algorithm, to obtain position information of the object adding portion; adding the virtual object to the object adding portion based on the position information; and acquiring depth information of the virtual object after adding, to obtain the first depth map.

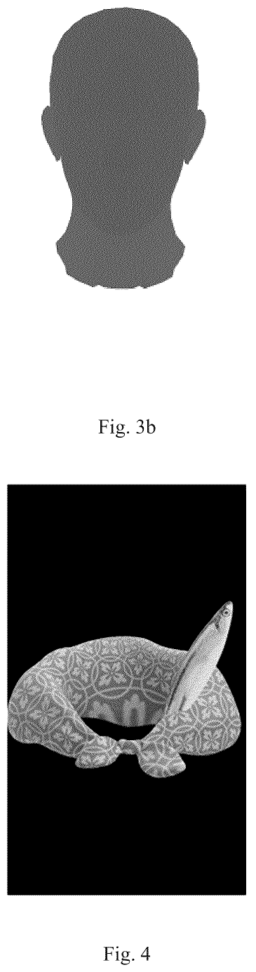

The object adding portion is a portion where the virtual object is added to the target object. The set tracking algorithm may be a tracking algorithm in the related art. The position information may be characterized by a transformation matrix. Exemplarily, the tracking algorithm is configured to, during the process of tracking the addition portion, obtain a transformation matrix corresponding to the object adding portion, multiply a matrix corresponding to the virtual object with the transformation matrix to achieve the operation of adding the virtual object to the object adding portion, and finally acquire depth information of the virtual object after adding using the virtual camera, to obtain the first depth map. Illustratively, FIG. 3a is a depth map of a virtual object in the present embodiment. As shown in FIG. 3a, the map is a depth map of a “virtual neck pillow”. In this embodiment, acquiring the depth map after adding the virtual object to the target object can improve the accuracy of the subsequent depth detection.

In this embodiment, the manner of acquiring the second depth map of the standard virtual model may be: tracking a set portion based on a set tracking algorithm, to obtain position information of the set portion; adding the standard virtual model to the set portion based on the position information; and acquiring depth information of the standard virtual model after adding, to obtain the second depth map.

The position information may be characterized by a transformation matrix. The set portion may be a face. Exemplarily, in the process of tracking the set portion, the set tracking algorithm obtains a transformation matrix corresponding to the set portion, multiplies a matrix corresponding to the standard virtual model with the transformation matrix, to achieve the operation of adding the standard virtual model to the set portion, and finally obtains depth information of the standard virtual model after adding using the virtual camera, to obtain the second depth map. Illustratively, FIG. 3b is a depth map of the standard virtual model in the present embodiment. As shown in FIG. 3b, the map is a depth map of a “virtual human head”.

S130, adjusting the initial mask map based on the first depth map and the second depth map to obtain a target mask map.

In the present embodiment, the principle of adjusting the initial mask map based on the first depth map and the second depth map may be understood as: determining whether a corresponding pixel in the set portion is occluded by the virtual object based on the depth values of corresponding pixels in the first depth map and the second depth map, and if yes, adjusting the pixel value of the corresponding pixel in the initial mask map, so that the adjusted mask map embodies the occlusion relation of the virtual object and the set portion of the target object.

Optionally, the process of adjusting the initial mask map based on the first depth map and the second depth map to obtain the target mask map may be: acquiring a near plane depth value and a far plane depth value of the virtual camera; linear transforming the first depth map and the second depth map according to the near plane depth value and the far plane depth value, respectively; and adjusting the initial mask map based on the first depth map and the second depth map after linear transforming to obtain the target mask map.

The near plane depth value and the far plane depth value may be directly obtained from the configuration information (such as the field angle) of the virtual camera. Linear transforming the first depth map and the second depth map, respectively, may be understood as: transforming the depth values in the first depth map and the second depth map into a range of the near plane depth value and the far plane depth value.

Optionally, the formula for linear transforming the first depth map and the second depth map, respectively, may be expressed as:

$$L ( d ) = \frac{2 * zNear * zFar}{( zFar + zNear - ( 2 d - 1 ) * ( zFar - zNear ) )} .$$

L (d) represents the depth value after linear transforming, d represents the depth value before linear transforming, zNear is the near plane depth value, and zFar is the far plane depth value. In this embodiment, linear transforming the depth values in the first depth map and the second depth map into a range of the near plane depth value and the far plane depth value can improve the accuracy of adjusting the mask map.

For example, the manner of adjusting the initial mask map based on the first depth map and the second depth map to obtain the target mask map may be: in the case where a first depth value in the first depth map is greater than a second depth value in the second depth map, keeping the pixel value of the corresponding pixel in the initial mask map unchanged; in the case where the first depth value is less than or equal to the second depth value, adjusting the pixel value of the corresponding pixel in the initial mask map to a set value.

The first depth value may be characterized by one of the channel values (e.g., R channel) in the first depth map; the second depth value may be characterized by one of the channel values (e.g., R channel) in the second depth map; the pixel value of the pixel in the initial mask map may be characterized by one of the channel values (e.g., R channel). Since the first depth map, the second depth map, and the initial mask map are all grayscale maps, the values of the three color channels (Red, Green, Blue, RGB) are equal, so that one channel value can be arbitrarily selected.

In an embodiment, the set value may be set to 0. In this embodiment, when the first depth value in the first depth map is greater than the second depth value in the second depth map, indicating that the virtual object is located behind the set portion, and the set portion is not occluded by the virtual object, then the pixel value of the corresponding pixel in the initial mask map remains unchanged; when the first depth value is less than or equal to the second depth value, indicating that the virtual object is in front of the set portion and the virtual object occludes the set portion, the pixel value of the corresponding pixel in the initial mask map is adjusted to 0. In this embodiment, the virtual object occludes the set portion, and the pixel value of the corresponding pixel in the initial mask map is adjusted to 0, so that the speed of adjusting the mask map can be improved.

Optionally, the manner of adjusting the initial mask map based on the first depth map and the second depth map to obtain the target mask map may be: obtaining a two-dimensional map of the virtual object; in the case where the first depth value in the first depth map is greater than the second depth value in the second depth map, keeping the pixel value of the corresponding pixel in the initial mask map unchanged; in the case where the first depth value is less than or equal to the second depth value, subtracting a set channel value of the corresponding pixel in the two-dimensional map from the pixel value of the corresponding pixel in the initial mask map to obtain a final pixel value.

In an embodiment, the manner of obtaining the two-dimensional map of the virtual object may be: projecting 3D points constituting the virtual object onto a two-dimensional plane to obtain a corresponding two-dimensional map of the virtual object. The set channel may be an A channel in the two-dimensional image. In this embodiment, the two-dimensional map includes four channels, which are RGBA, in which RGB represents three color channels, and A channel is the Alpha channel, and a value of the A channel is between 0 and 1, which represents the transparency of the pixel. When the A channel value is 0, it indicates that the pixel is transparent, and when the A channel value is greater than 0, it indicates that the pixel is not transparent. Illustratively, FIG. 4 is an example of a two-dimensional map in the present embodiment. As shown in FIG. 4, the map is a corresponding two-dimensional map of the “virtual neck pillow,” the black region is a transparent region, i.e., the A channel value is 0, as shown in FIG. 4.

For example, when the first depth value in the first depth map is greater than the second depth value in the second depth map, indicating that the virtual object is located behind the set portion, and the set portion is not occluded by the virtual object, then the pixel value of the corresponding pixel in the initial mask map remains unchanged. When the first depth value is less than or equal to the second depth value, indicating that the virtual object is in front of the set portion, the virtual object occludes the set portion, and the A channel value of the corresponding pixel in the two-dimensional map is subtracted from the pixel value of the corresponding pixel in the initial mask map. Illustratively, FIG. 5 is an exemplary diagram of the mask map after adjusting in the present embodiment, and it can be seen that, with respect to the initial mask map of FIG. 2, in the target mask map of FIG. 5, the pixel values of the pixels in the region where the set portion is occluded by the virtual object are adjusted. In this embodiment, when the virtual object occludes the set portion, the A channel value of the corresponding pixel in the two-dimensional map is subtracted from the pixel value of the corresponding pixel in the initial mask map to improve the smoothness of the edge, so that the occlusion transition is smoothed and the rendered image is more realistic.

S140, rendering the set portion based on the target mask map to obtain a set portion map; and rendering the virtual object to obtain a virtual object map.

In this embodiment, the target mask can characterize which pixels of the set portion are occluded by the virtual object, and thus, when rendering the set portion based on the mask map, only non-occluded pixels can be rendered, or the transparency of occluded pixels can be adjusted to 0.

Optionally, the manner of rendering the set portion based on the target mask map may be: fusing image information corresponding to the target mask map with image information corresponding to an original map of the set portion to obtain fused image information; and rendering the set portion based on the fused image information.

In an embodiment, the image information may be represented by a matrix of the same size as the image, each element of the matrix represents a pixel value of a corresponding pixel. The manner of fusing the image information corresponding to the target mask map with the image information corresponding to the original map of the set portion may be: multiplying pixel values of the corresponding pixels in the original map of the set portion and the target mask map, to obtain the fused image information. In this embodiment, since the fused image information includes the final pixel value of the pixel, the set portion is rendered based on the final pixel value of the pixel. In this embodiment, the rendering is performed after the target mask map is fused with the original map, the rendered set portion map accurately represents the occlusion relation with the virtual object.

Optionally, the manner of rendering the set portion based on the target mask map may be: determining transparency information of a pixel in an original map of the set portion according to the target mask map; and rendering the set portion based on the transparency information.

The pixel value of the pixel in the target mask map characterizes the transparency. The pixel value of the pixel in the target mask map is a value between 0 and 1, and when the pixel value is 0, it indicates that the pixel corresponding to the pixel in the set portion map is transparent, and when the pixel value is greater than 0, it indicates that the pixel corresponding to the pixel in the set portion map is non-transparent, and the transparency is determined by the actual pixel value. For example: when the pixel value is 1, the transparency is 100%, when the pixel value is 0.5, the transparency is 50%. In this embodiment, the amount of calculation can be reduced by rendering the set portion based on the transparency information.

Optionally, when there are a plurality of virtual object, the manner of obtaining the first depth map of the virtual object may be: obtaining a plurality of first depth maps corresponding to the plurality of virtual objects, respectively.

Accordingly, the manner of rendering the virtual object may be: rendering a plurality of virtual objects based on the plurality of first depth maps.

For example, the process of rendering the plurality of virtual objects based on the plurality of first depth maps may be: comparing depth values in the plurality of depth maps, and rendering the pixel in the virtual object having the smallest depth value. Assume that two virtual objects, which are respectively virtual object a and virtual object, are included, the corresponding depth maps are respectively first depth map a and first depth map b, for one pixel, when the first depth value a is smaller than the first depth value b, the pixel in the virtual object A is rendered. In this embodiment, the pixel in the virtual object having the smallest depth value is rendered, so that the rendered virtual object exhibits a respective occlusion relation to improve the realism of the image.

Optionally, when there are a plurality of virtual objects, determining a set virtual object from the plurality of virtual objects; and the acquiring of the second depth map of the standard virtual model includes: using a virtual camera to acquire the standard virtual model and the depth information of the set virtual object, to obtain the second depth map.

The set virtual object may be selected by the user according to the actual shape of the virtual object (e.g., earring). In order to ensure a better fit of the set virtual object and the target object, the depth information of the standard virtual model and the set virtual object are placed in the same depth map when performing the depth detection, thereby better integrating the set virtual object and the target object. Exemplarily, the second depth map is obtained by acquiring depth information of the set virtual object and the standard virtual model using the same virtual camera.

S150, superimposing the set portion map and the virtual object map to obtain a target image.

The manner of superimposing the set portion map and the virtual object map may be: superimposing the set portion map onto the virtual object map. In this embodiment, the set portion map and the virtual object map are rendered by different virtual camera, and are respectively in different map layers, superimposing the set portion map onto the virtual object map, such that the set portion map overlays the virtual object map, thereby generating the target image. In this embodiment, when the first depth value is less than or equal to the second depth value, the pixels of the region in the set portion map have been set to be transparent or not rendered, so that the virtual object is not occluded; when the first depth value is greater than the second depth value, the pixels of the region in the set portion map have been rendered in color, which occludes the virtual object, making the target image more realistic.

Optionally, after obtaining the target mask map, the method further includes the step of: caching the target mask map. Accordingly, the manner of rendering the set portion based on the target mask map to obtain the set portion map; and rendering the virtual object to obtain the virtual object map may be: for a current frame, rendering the set portion based on a target mask map corresponding to a set forward frame, to obtain the set portion map; and rendering the virtual object corresponding to the set forward frame to obtain the virtual object map.

The set forward frame may be a sequence forward frame spaced apart from the current frame by a set number of sequences. In this embodiment, there may be a frame delay problem due to differences in processing speeds of different algorithms, and in order to ensure that the overall algorithm result is consistent with the actual display effect, the image currently displayed on the screen is replaced by an image before N frames. N may be determined according to the actual processing speed of each algorithm, for example: N may be 3.

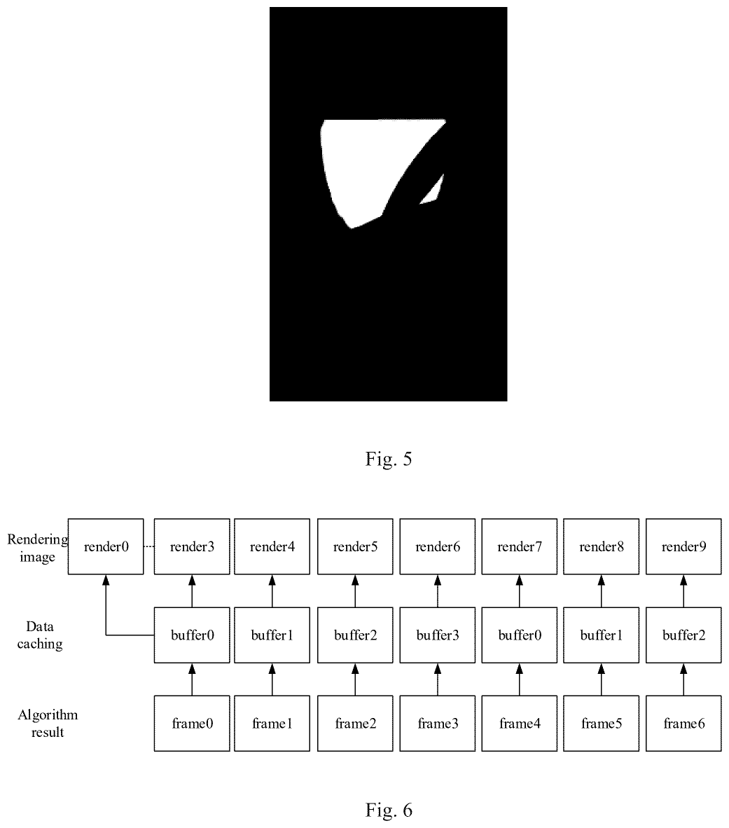

In the present embodiment, the determined target mask is first cached, and for the current frame, the target mask map corresponding to the set forward frame is obtained from the cache, to render the set portion; and the virtual object corresponding to the set forward frame is rendered. Since the first N frames have no algorithmic data, the data determined by the 0th frame can be used to render. Illustratively, FIG. 6 is an exemplary diagram of processing a frame delay in the present embodiment. As shown in FIG. 6, render0-render3 are rendered using the data in buffer0, and subsequent rendered images are rendered using the data corresponding to the data before three frames. In this embodiment, the problem of frame delay of the rendered image can be avoided.

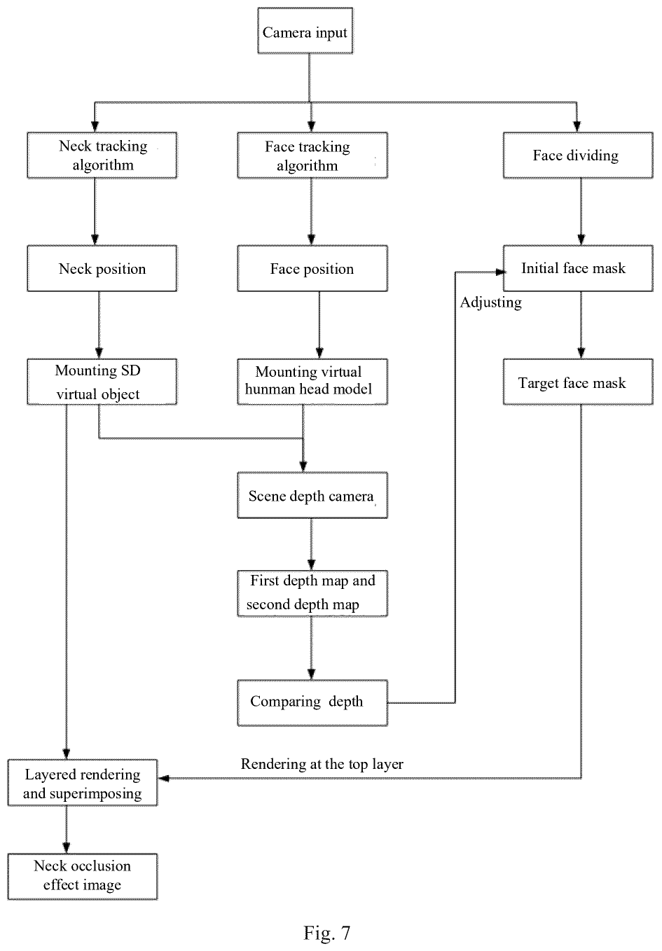

Illustratively, FIG. 7 is an exemplary diagram of adding a virtual object to a target object in the present embodiment, which takes the adding of a virtual object on a person's neck as an example. As shown in FIG. 7, the camera of the terminal captures a human body image in real time, a neck tracking algorithm is used to track the neck, to obtain a neck position, and a virtual object is mounted at the neck position. A face tracking algorithm is used to track the face, to obtain a face position, and the virtual human head model is mounted based on the face position. The face is divided using a face dividing algorithm to obtain an initial face mask map. A depth camera is used to obtain a first depth map of the virtual object and a second depth map of the virtual human head model. Comparing depth values of the first depth map and the second depth map, adjusting a pixel value in the initial face mask map based on the comparison result, to obtain a target face mask map. Respectively rendering the face image and the virtual object map in different layers, and superimposing the face image onto the virtual object map to obtain a neck occlusion effect map.

Exemplarily, one application scenario of the present embodiment is to add a virtual animal, such as a cat or a dog, to the shoulder of a person, in this case, the solution in the above embodiments is used to determine an occlusion relation between the virtual animal, the shoulder of the human body and the face of the human body, and to render the virtual animal, the shoulder of the human body and the face of the human body based on the occlusion relation, thereby obtaining a special effect of adding the virtual animal to the shoulder of the human body. In another application scenario, a virtual neck pillow may be mounted on the neck of a human body, in this case, the solution in the above embodiments is used to determine an occlusion relation between the virtual animal, the neck of the human body and the face of the human body, and to render the virtual neck pillow, the neck of the human body and the face of the human body based on the occlusion relation, thereby obtaining the specific effect of mounting the virtual neck pillow to the neck of the human body.

In the technical solution of the embodiments of the present disclosure, the set portion of the target object is divided to obtain an initial mask map; a first depth map of the virtual object and a second depth map of the standard virtual model are acquired; the initial mask map is adjusted based on the first depth map and the second depth map to obtain a target mask map; the set portion is rendered based on the target mask map to obtain a set portion map; the virtual object is rendered to obtain a virtual object map; and the set portion map is superimposed onto the virtual object map to obtain a target image. The image processing method according to the embodiments of the present disclosure renders the set portion based on the target mask map and superimposes the set portion map onto the virtual object map, which can achieve the adding of the virtual object to the target object and improve the realism of the virtual object.

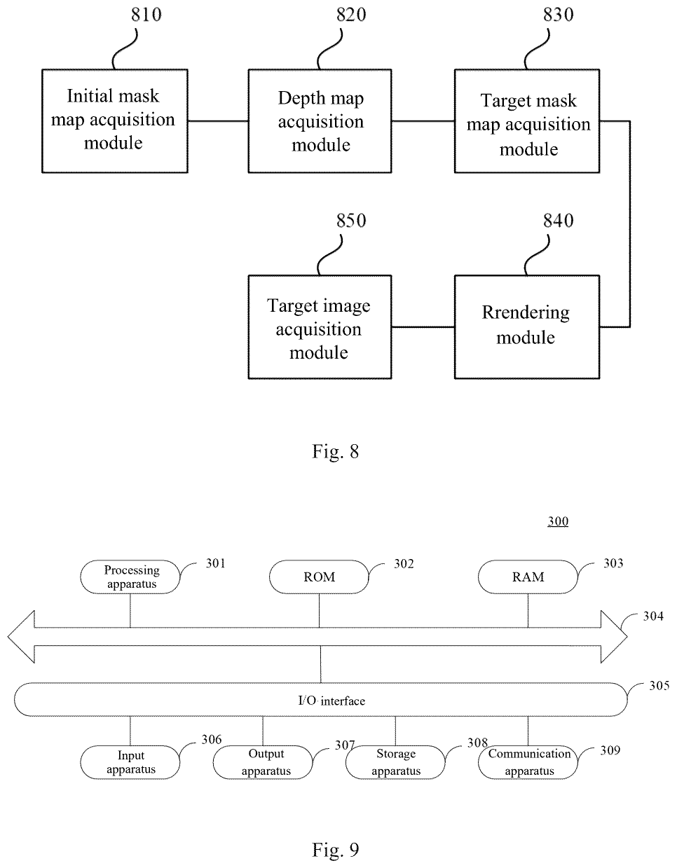

FIG. 8 is a structural diagram of an image processing apparatus disclosed by the embodiments of the present disclosure, as shown in FIG. 8, the apparatus includes:
an initial mask map acquisition module 810, configured to divide a set portion of a target object to obtain an initial mask map;
a depth map acquisition module, configured to acquire a first depth map of a virtual object and a second depth map of a standard virtual model relating to the target object;
a target mask map acquisition module 830, configured to adjust the initial mask map based on the first depth map and the second depth map to obtain a target mask map;
a rendering module 840, configured to render the set portion based on the target mask map to obtain
a set portion map; and render the virtual object to obtain a virtual object map; and
a target image acquisition module 850, configured to superimpose the set portion map and the virtual object map to obtain a target image

Optionally, the depth map acquisition module 820 is configured to acquire the first depth map of the virtual object in the following way:
tracking an object adding portion based on a set tracking algorithm to obtain position information of the object adding portion; in which the object adding portion is a portion of the target object to which the virtual object is added;
adding the virtual object to the object adding portion based on the position information; and
obtaining depth information of the virtual object after adding to obtain the first depth map.

Optionally, the standard virtual model is a virtual model of a shape of the target object, or a virtual model associated with the shape of the target object, or a virtual model constructed for the target object based on the current frame.

Optionally, the target mask map acquisition module 830 is configured to obtain the target mask in the following way:
acquiring a near plane depth value and a far plane depth value of a virtual camera;
linear transforming the first depth map and the second depth map according to the near plane depth value and the far plane depth value, respectively; and
adjusting the initial mask map based on the first depth map and the second depth map after linear transforming to obtain the target mask map.

Optionally, the target mask map acquisition module 830 is further configured to obtain the target mask map in the following way:
in response to a first depth value in the first depth map being greater than a second depth value in the second depth map, keeping a pixel value of a corresponding pixel in the initial mask map unchanged;
in response to the first depth value being less than or equal to the second depth value, adjusting a pixel value of a corresponding pixel in the initial mask map to a set value.

Optionally, the target mask map acquisition module 830 is further configured to obtain the target mask map in the following way:
acquiring a two-dimensional map of the virtual object;
in response to a first depth value in the first depth map being greater than a second depth value in the second depth map, keeping a pixel value of a corresponding pixel in the initial mask map unchanged;
in response to the first depth value being less than or equal to the second depth value, subtracting a set channel value of a corresponding pixel in the two-dimensional map from a pixel value of a corresponding pixel in the initial mask map to obtain a final pixel value.

Optionally, the rendering module 840 is configured to render the set portion based on the target mask map in the following way:
fusing image information corresponding to the target mask map with image information corresponding to an original map of the set portion to obtain fused image information; and
rendering the set portion based on the fused image information.

Optionally, the rendering module 840 is configured to render the set portion based on the target mask in the following way:
determining transparency information of a pixel in an original map of the set portion according to the target mask map; in which a pixel value of the pixel in the target mask map characterizes transparency; and

Optionally, there are a plurality of virtual objects, and the depth map acquisition module 820 is configured to obtain the first depth map in the following way:
acquiring a plurality of first depth maps respectively corresponding to the plurality of virtual objects;
the rendering module 840 is configured to render the virtual object in the following way:
rendering the plurality of virtual objects based on the plurality of first depth maps.

Optionally, the apparatus further includes: a virtual object determination module, configured to: in response to there being a plurality of virtual objects, determine a set virtual object from the plurality of virtual objects;
the depth map acquisition module 820 is configured to obtain the second depth map in the following way:
acquiring depth information of the set virtual object and the standard virtual model using a virtual camera to obtain the second depth map.

Optionally, the apparatus further includes a caching module, configured to: cache the target mask map;
the rendering module 840 is configured to obtain the virtual object map in the following way:
for a current frame, rendering the set portion based on a target mask map corresponding to a set forward frame to obtain the set portion map; and rendering a virtual object corresponding to the set forward frame to obtain the virtual object map

The apparatus described above can perform the method provided by all the embodiments described above in the present disclosure, and have the corresponding functional modules to perform the method described above and advantageous effects. The technical details, which are not elaborately described in the present embodiment, can be referred to the method provided by all the above embodiments of the present disclosure.

FIG. 9 is referred below, and it shows the structural diagram suitable for achieving the electronic device 300 in the embodiments of the present disclosure. The electronic device in the embodiments of the present disclosure may include but not be limited to a mobile terminal such as a mobile phone, a notebook computer, a digital broadcasting receiver, a personal digital assistant (PDA), a portable android device (PAD), a portable media player (PMP), a vehicle terminal (such as a vehicle navigation terminal), and a fixed terminal such as a digital television (that is, a digital TV) and a desktop computer, and a server of various forms, such as stand-alone server or a server cluster. The electronic device shown in FIG. 9 is only an example.

As shown in FIG. 9, the electronic device 300 may include a processing apparatus (such as a central processing unit, and a graphics processor) 301, it may execute various appropriate actions and processes according to a program stored in a read-only memory (ROM) 302 or a program loaded from a storage apparatus 308 to a random access memory (RAM) 303. In RAM 303, various programs and data required for operations of the electronic device 300 are also stored. The processing apparatus 301, ROM 302, and RAM 303 are connected to each other by a bus 304. An input/output (I/O) interface 305 is also connected to the bus 304.

Typically, the following apparatuses may be connected to the I/O interface 305: an input apparatus 306 such as a touch screen, a touchpad, a keyboard, a mouse, a camera, a microphone, an accelerometer, and a gyroscope; an output apparatus 307 such as a liquid crystal display (LCD), a loudspeaker, and a vibrator; a storage apparatus 308 such as a magnetic tape, and a hard disk drive; and a communication apparatus 309. The communication apparatus 309 may allow the electronic device 300 to wireless-communicate or wire-communicate with other devices so as to exchange data. Although FIG. 9 shows the electronic device 300 with various apparatuses, it should be understood that it is not required to implement or possess all the apparatuses shown. Alternatively, it may implement or possess the more or less apparatuses.

Specifically, according to the embodiments of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 309, or installed from the storage apparatus 308, or installed from ROM 302. When the computer program is executed by the processing apparatus 301, the above functions defined in the method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also be present separately and not incorporated into the electronic device.

The computer-readable medium carries at least one program, when the at least one program is executed by the electronic device, the electronic device is caused to: divide a set portion of a target object to obtain an initial mask map; acquire a first depth map of a virtual object and a second depth map of a standard virtual model relating to the target object; adjust the initial mask map based on the first depth map and the second depth map to obtain a target mask map; render the set portion based on the target mask map to obtain a set portion map; and rendering the virtual object to obtain a virtual object map; and superimpose the set portion map and the virtual object map to obtain a target image.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on at least one wire, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above.

According to one or more embodiments of the embodiments of the present disclosure, the embodiments of the present disclosure disclose an image processing method, which includes:
dividing a set portion of a target object to obtain an initial mask map;
acquiring a first depth map of a virtual object and a second depth map of a standard virtual model relating to the target object;
adjusting the initial mask map based on the first depth map and the second depth map to obtain a target mask map;
rendering the set portion based on the target mask map to obtain a set portion map; and rendering the virtual object to obtain a virtual object map; and
superimposing the set portion map and the virtual object map to obtain a target image.

Further, the acquiring of the first depth map of the virtual object includes:
tracking an object adding portion based on a set tracking algorithm to obtain position information of the object adding portion; in which the object adding portion is a portion of the target object to which the virtual object is added;
adding the virtual object to the object adding portion based on the position information; and
acquiring depth information of the virtual object after adding to obtain the first depth map.

Further, the standard virtual model is a virtual model of a shape of the target object, or the standard virtual model is a virtual model associated with a shape of the target object, or the standard virtual model is a virtual model constructed based on the target object of a current frame.

Further, the adjusting of the initial mask map based on the first depth map and the second depth map to obtain a target mask map includes:
acquiring a near plane depth value and a far plane depth value of a virtual camera;
linear transforming the first depth map and the second depth map according to the near plane depth value and the far plane depth value, respectively; and
adjusting the initial mask map based on the first depth map and the second depth map after linear transforming to obtain the target mask map.

Further, the adjusting of the initial mask map based on the first depth map and the second depth map to obtain the target mask map includes:
in response to a first depth value in the first depth map being greater than a second depth value in the second depth map, keeping a pixel value of a corresponding pixel in the initial mask map unchanged;
in response to the first depth value being less than or equal to the second depth value, adjusting a pixel value of a corresponding pixel in the initial mask map to a set value.

Further, the adjusting of the initial mask map based on the first depth map and the second depth map to obtain the target mask map includes:
acquiring a two-dimensional map of the virtual object;
in response to a first depth value in the first depth map being greater than a second depth value in the second depth map, keeping a pixel value of a corresponding pixel in the initial mask map unchanged;
in response to the first depth value being less than or equal to the second depth value, subtracting a set channel value of a corresponding pixel in the two-dimensional map from a pixel value of a corresponding pixel in the initial mask map to obtain a final pixel value.

Further, the rendering of the set portion based on the target mask map includes:
fusing image information corresponding to the target mask map with image information corresponding to an original map of the set portion to obtain fused image information; and
rendering the set portion based on the fused image information.

Further, the rendering of the set portion based on the target mask map includes:
determining transparency information of a pixel in an original map of the set portion according to the target mask map; in which a pixel value of the pixel in the target mask map characterizes transparency; and
rendering the set portion based on transparency information.

Further, there are a plurality of virtual objects, the acquiring of the first depth map of the virtual object includes:
acquiring a plurality of first depth maps respectively corresponding to the plurality of virtual objects;
the rendering of the virtual object includes:
rendering the plurality of virtual objects based on the plurality of first depth maps.

Further, the method further includes:
in response to there being a plurality of virtual objects, determining a set virtual object from the plurality of virtual objects;
the acquiring of the second depth map of the standard virtual model relating to the target object includes:
acquiring depth information of the set virtual object and the standard virtual model using a virtual camera to obtain the second depth map.

Further, after obtaining the target mask map, the method further includes:
caching the target mask map;
the rendering of the set portion based on the target mask map to obtain the set portion map; and the rendering of the virtual object to obtain a virtual object map include:
for a current frame, rendering the set portion based on a target mask map corresponding to a set forward frame to obtain the set portion map; and rendering a virtual object corresponding to the set forward frame to obtain the virtual object map.

It should be understood that various forms of the flow shown above may be used, with steps reordered, added, or deleted. For example, the respective steps recited in the present disclosure may be executed in parallel, may be executed sequentially, or may be executed in different orders, as long as the desired results of the technical solutions of the present disclosure can be achieved.

1. An image processing method, comprising:
dividing a set portion of a target object to obtain an initial mask map;
acquiring a first depth map of a virtual object and a second depth map of a standard virtual model relating to the target object;
adjusting the initial mask map based on the first depth map and the second depth map to obtain a target mask map;
rendering the set portion based on the target mask map to obtain a set portion map; and
rendering the virtual object to obtain a virtual object map; and
superimposing the set portion map and the virtual object map to obtain a target image.

2. The method according to claim 1, wherein the acquiring of the first depth map of the virtual object comprises:
tracking an object adding portion based on a set tracking algorithm to obtain position information of the object adding portion; wherein the object adding portion is a portion of the target object to which the virtual object is added;
adding the virtual object to the object adding portion based on the position information; and
acquiring depth information of the virtual object after adding to obtain the first depth map.

3. The method according to claim 1, wherein the standard virtual model is a virtual model of a shape of the target object, or the standard virtual model is a virtual model associated with a shape of the target object, or the standard virtual model is a virtual model constructed based on the target object of a current frame.

4. The method according to claim 1, wherein the adjusting of the initial mask map based on the first depth map and the second depth map to obtain the target mask map comprises:
acquiring a near plane depth value and a far plane depth value of a virtual camera;
linear transforming the first depth map and the second depth map according to the near plane depth value and the far plane depth value, respectively; and
adjusting the initial mask map based on the first depth map and the second depth map after linear transforming to obtain the target mask map.

5. The method according to claim 1- or 4, wherein the adjusting of the initial mask map based on the first depth map and the second depth map to obtain the target mask map comprises:
in response to a first depth value in the first depth map being greater than a second depth value in the second depth map, keeping a pixel value of a corresponding pixel in the initial mask map unchanged;
in response to the first depth value being less than or equal to the second depth value, adjusting a pixel value of a corresponding pixel in the initial mask map to a set value.

6. The method according to claim 1, wherein the adjusting of the initial mask map based on the first depth map and the second depth map to obtain the target mask map comprises:
acquiring a two-dimensional map of the virtual object;
in response to a first depth value in the first depth map being greater than a second depth value in the second depth map, keeping a pixel value of a corresponding pixel in the initial mask map unchanged;
in response to the first depth value being less than or equal to the second depth value, subtracting a set channel value of a corresponding pixel in the two-dimensional map from a pixel value of a corresponding pixel in the initial mask map to obtain a final pixel value.

7. The method according to claim 1, wherein the rendering of the set portion based on the target mask map comprises:
fusing image information corresponding to the target mask map with image information corresponding to an original map of the set portion to obtain fused image information; and
rendering the set portion based on the fused image information.

8. The method according to claim 1, wherein the rendering of the set portion based on the target mask map comprises:
determining transparency information of a pixel in an original map of the set portion according to the target mask map; wherein a pixel value of the pixel in the target mask map characterizes transparency; and
rendering the set portion based on transparency information.

9. The method according to claim 1, wherein there are a plurality of virtual objects, and the acquiring of the first depth map of the virtual object comprises:
acquiring a plurality of first depth maps respectively corresponding to the plurality of virtual objects;
wherein the rendering of the virtual object comprises:
rendering the plurality of virtual objects based on the plurality of first depth maps.

10. The method according to claim 1, further comprising:
in response to there being a plurality of virtual objects, determining a set virtual object from the plurality of virtual objects;
wherein the acquiring of the second depth map of the standard virtual model relating to the target object comprises:
acquiring depth information of the set virtual object and the standard virtual model using a virtual camera to obtain the second depth map.

11. The method according to claim 1, after obtaining the target mask map, the method further comprising:
caching the target mask map;
wherein the rendering of the set portion based on the target mask map to obtain the set portion map; and the rendering of the virtual object to obtain the virtual object map comprise:
for a current frame, rendering the set portion based on a target mask map corresponding to a set forward frame to obtain the set portion map; and rendering a virtual object corresponding to the set forward frame to obtain the virtual object map.

12. (canceled)

13. An electronic device, comprising:
at least one processor; and
a memory, configured to store a program;
when the program is executed by the at least one processor, the at least one processor is caused to:
divide a set portion of a target object to obtain an initial mask map;
acquire a first depth map of a virtual object and a second depth map of a standard virtual model relating to the target object;
adjust the initial mask map based on the first depth map and the second depth map to obtain a target mask map;
render the set portion based on the target mask map to obtain a set portion map; and render the virtual object to obtain a virtual object map; and
superimpose the set portion map and the virtual object map to obtain a target image.

14. A computer readable medium, wherein a computer program is stored on the computer readable medium, and when the computer program is executed by a processing apparatus, the computer program implements an image processing method comprising:
dividing a set portion of a target object to obtain an initial mask map;
acquiring a first depth map of a virtual object and a second depth map of a standard virtual model relating to the target object;
adjusting the initial mask map based on the first depth map and the second depth map to obtain a target mask map;
rendering the set portion based on the target mask map to obtain a set portion map; and
rendering the virtual object to obtain a virtual object map; and
superimposing the set portion map and the virtual object map to obtain a target image.
